(19) United States
(12) Patent Application Publication
(10) Pub. No.: US 2001/0022778 A1
(43) Pub. Date: Sep. 20, 2001

(54) Packet communication system

(75) Inventors: Masaki Ito, Haguri (JP); Tohru Nishioka, Urawa (JP)

Correspondence Address: HELFGOTT & KARAS, P.C., Empire State Building, 60th Floor, New York, NY, 10118-0110, US

(73) Assignee: FUJITSU LIMITED

(21) Appl. No.: 09/741,509

(22) Filed: Dec. 19, 2000

(30) Foreign Application Priority Data
Mar. 17, 2000 (JP) 2000-076937

(51) Int. Cl. H04J 1/16

(52) U.S. Cl. 370/242; 370/352

(57) ABSTRACT

In a working environment in which a connection is made between a router device installed in a SOHO and a management division, etc. at a remote location, a router system accommodates multiple user terminals. The router system has a monitoring unit that monitors the communicability state of the user terminals, and an editing communication unit that, when there has been any change in the communicability state of the user terminals, edits and transmits information on the communicability state of the user terminals.

### BACKGROUND OF THE INVENTION

1. Field of the Invention

The present invention relates to a packet communication system that monitors the state of operation of some or all of the terminals connected to the packet communication system and performs operations according to changes in their state of operation.

2. Description of the Prior Art

With the increasing diversity of workplaces in recent years, including branches, branch offices, and at-home work, much attention has begun to be paid to new modes of work such as SOHO (small office home office) or telework (hereafter, these are referred to as SOHO).

This mode of work is said to offer the employer the advantage of reducing transportation, office, and other expenses, while offering the employee the advantage of efficient use of time due to a shorter commuting time and the ability to select one's hours of work to suit one's own circumstances.

Such a working regime entails the possibility that problems will arise in how work is being done outside the direct oversight of the management division. As an example for solving such problems, in some cases a management mode is put in operation in which a monitoring camera is set up in the workplace using an ISDN (Integrated Services Digital Network) line (circuit) and the state of the work is captured. But at present it is generally more frequent to entrust this to the autonomous management and operation of the SOHO side.

Because the SOHO working environment has come to depend to a large extent on information communication technology, LAN/WAN is assuming ever greater importance for information collection and as a means of communication with the outside. Against this background, there is a desire to offer those who move to a place where the workplace is other than a SOHO (for example, those who are involved in sales) the same sort of communication environment as in a SOHO in the environment they move to.

In particular, e-mail employing the Internet has established as a communication means and is actively used in business. In recent years, the exchange of e-mail by portable information terminals and PDAs (personal digital assistants) has also become more commonplace, and many people contract with two or more providers and have several e-mail addresses. When such a SOHO worker transmits and/or receives e-mail over the Internet, generally the connection to the Internet is made via a provider by dial-up connection using a public (ISDN/wireless), but sometimes the connection is made from the SOHO to a mail server at the head office, etc. over a public line.

In such a SOHO, it has become possible, by making full use of information communication technology and the timely exchange of information, to create a working environment that is no different from that in the head office, etc. But there are also cases in which received e-mail is kept on a SOHO mail server, which leads to the problem that because the mail server cannot be directly accessed with the e-mail functions of a portable information terminal (including a mobile information terminal) at an aforesaid remote location, the e-mail cannot be received.

If, in consideration of security, operations are executed in which access from the public network by dial-up, etc. to a server inside a SOHO is prohibited, there arises the problem that the e-mail cannot be received because one cannot directly access the mail server over the outside public network. For example, there is an operation in which if one is to access the mail server within the company, the only connection allowed is with a preregistered called party number.

There is a desire to ascertain how work is being conducted at a SOHO to cope with the change in workstyle to such new working environments.

And there is also a desire to provide an environment allowing access to e-mail from a remote location the same as for a SOHO.

### SUMMARY OF THE INVENTION

It is therefore an object of the present invention to provide a means to make it easy to ascertain, by a simple composition, a state of work at a SOHO so as to cope with changes in workstyle for such a new working environment.

It is another object of the present invention to provide a system to transfer e-mail to a designated transfer destination in a timely way when e-mail, having arrived at a terminal address, is not in a condition that can be received by a user.

The above and other objects of the present invention are attained by a packet communication system that comprises a monitoring unit which monitors a communicability state on terminals, detects a change between a current communicability state of the terminals and a previous communicability state of the terminals, and transmits monitoring results of the terminals; and a editing communication unit which edits the monitoring results of the terminals and transmits edited monitoring results on a network.

Also, the editing communication unit of the packet communication system sets to incommunicable state a terminal that has been in incommunicable state for a period of time or longer.

Also, the editing communication unit edits the monitoring results of the terminals in e-mail format and transmits edited monitoring results to a server.

Also, the editing communication unit of the packet communication system edits the communicability state information of the terminals in a tagged-text format and provides it to a World Wide Web server as a file name including a date and/or time of day.

The information editing unit of the packet communication system also edits the communicability state information of the terminals into a table-format data and provides it to an FTP server as a file name including a date and/or time of day.

In the packet communication system of the present invention, billing information corresponding to the communication done by the terminals is included in the edited monitoring state.

In an embodiment, the packet communication system comprises a monitoring unit which monitors a communicability state on terminals, detects a change between a current communicability state of the terminals and a previous communicability state of the terminals, and transmits monitoring results of the terminals, and an agent reception and transfer unit which, when at least one terminal is in an incommunicable state, the agent reception and transfer unit receives e-mail instead of a user of a terminal that is in the incommunicable state and transfers the received e-mail to a desired transfer destination.

In an embodiment, the agent reception and transfer unit of the packet communication system receives e-mail instead of the user, including one or more prescribed characters in a title of the received e-mail, and transfers the received e-mail to the desired transfer destination.

In the agent reception and transfer unit of the packet communication system, if the prescribed characters are included in the title of the e-mail, it may declare the e-mail to be in an unread state.

In the agent reception and transfer unit of the packet communication system, if an e-mail address of the transmission origin of the e-mail before the e-mail is received agrees with the e-mail address used by the agent reception and transfer unit, the agent reception and transfer unit sets the e-mail to be in unread state.

### BRIEF DESCRIPTION OF THE DRAWINGS

FIG. 1 is a diagram showing an outline of monitoring operation of a user terminal by a router of the present invention;

FIG. 2 is a block diagram of an embodiment of a user terminal monitored by a router of the present invention;

FIG. 3 is a flow chart diagram of a processing flow for deciding a state of a user terminal connected to a router of the present invention;

FIG. 4 shows an example of an information format reported from a router of the present invention to a server;

FIG. 5 shows an outline of transfer operation of e-mail by a router of the present invention;

FIG. 6 shows a working example by which e-mail is transferred to a user terminal that is connected to a router of the present invention; and

FIG. 7 shows a flow chart diagram of a processing flow for transferring e-mail by a router of the present invention.

### DETAILED DESCRIPTION OF THE PREFERRED EMBODIMENTS

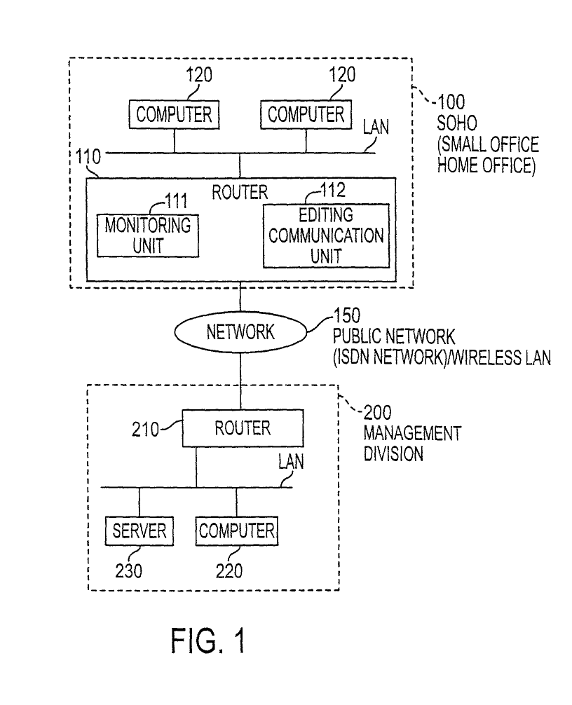

The main outline for helping to understand a first embodiment of the present invention is described along the lines of FIG. 1.

FIG. 1 is a diagram showing an outline of monitoring operation of a user terminal by a router of this invention.

In FIG. 1, SOHO 100 is a SOHO or telework office (hereafter referred to collectively as a SOHO), and installed in the SOHO 100, are a router 110 connected to a network 150, and one or more computers 120 connected to the router 110.

Router 210 is a router which is connected with the router 110 via the network 150, and is installed in a management division 200.

Computer 220 is at least one or more computers and is connected to router 210. Server 230 is at least one or more servers, and is connected to router 210. Network 150 (public line or wireless LAN, etc.), is mutually connected to the router 110 of SOHO 100 and the router 210 of management division 200.

Router 110 of the present invention includes a monitoring unit 111 and an editing communication unit 112. Monitoring unit 111 monitors and samples an operating condition (e.g. starting time, stopping time, billing information, etc. concerning network access, and preset user ID and name) of the user terminals (computers 120) LAN-connected to router 110, and holds their operating condition. The above system which is composed to include the above router 110 and computers 120 may also be a router system.

If there is any change between the previous and current monitored condition of each computer 120, on the occasion of such change, monitoring unit 111 notifies editing communication unit 112 of the monitored result. The editing communication unit 112 edits it as data in an e-mail format including the monitored results of each computer 120, and transmits it as e-mail over network 150 to server 230 of management division 200. Also, the editing communication unit 112 may carry out the transmission of e-mail including the monitored results to server 230 at fixed and/or variable intervals. Also, the e-mail may be transmitted to computer 220, etc. instead of server 230. All or some of the computers 120 monitored by the monitoring unit 111 may be connected to router 110. When all or some of the computers 120 are being monitored, it is necessary to set an identifier (for example, IP address or MAC address, etc.) of each computer that is subject to the router 110.

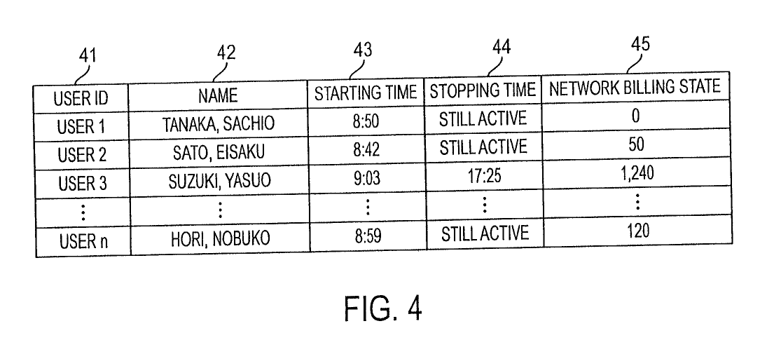

At server 230 at the management division 200, the content of the received e-mail is analyzed by computer 220, and the monitored state of each computer 120 can be ascertained as the operation condition (working condition). For example, the appropriateness of the content of the operations can be ascertained to some extent by comparing the written work report prepared by each worker with the billing information concerning each network access (as shown in FIG. 4).

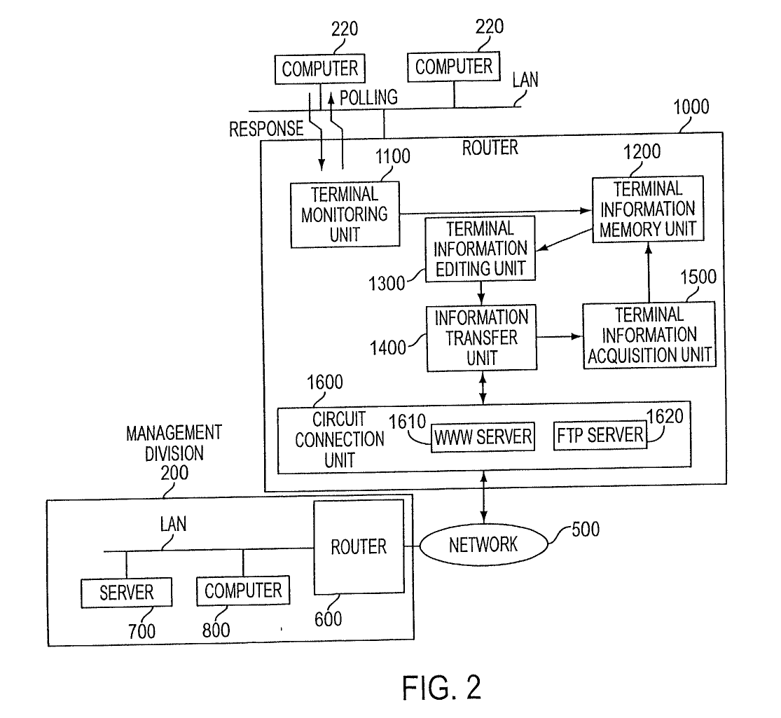

The detailed configuration of router 110 installed in the environment of such a SOHO 100 is shown in FIG. 2. FIG. 2 diagrammatically shows a working example of the user terminal monitoring by a router of the invention.

In FIG. 2 a terminal monitoring unit 1100 monitors at fixed and/or variable intervals whether each computer (user terminal) 220 connected to a router 1000 is in communicable state. The terminal monitoring unit 1100 polls the computers 220 (for example, a ping is sent to each computer 220 using a function equivalent to the ping command, and one ascertains whether a response from each computer 220 is obtained), and if there is a response from a computer 220, the computer 220 is known to be in operation as a network computer, while if there is no response, it is known not to be in operation. And if it currently is not in operation although shortly before it was in operation, trouble might have occurred such as the operating system being temporarily down. Therefore it can be assumed that essentially there will be few problems even if it is assumed that the user is not present if a lack of response continues for a certain time or longer.

This ping command is normally used for executing continuity confirmation on an Internet network whereby, between terminal devices connected to the Internet network, a request packet is sent from one to the other host, and the response packet is received as a reply to this request packet from this other host. This ping command is a program and is installed on many computers and workstations that can be connected to the Internet. Therefore one skilled in the art can easily prepare a ping-equivalent function.

Terminal monitoring unit 1100 stores in a terminal information memory unit 1200 the monitoring results of each computer 220 by fixed and/or variable intervals. Billing information concerning the use of communication in each computer 220 connected to router 1000 is reported from a network 500 (for example, ISDN network or wireless network LAN, etc.) to a terminal information acquisition unit 1500 via an information transfer unit 1400, terminal information acquisition unit 1500 reports it to terminal information memory unit 1200, and terminal information memory unit 1200 stores it corresponding to each computer. This storage format will be described later with reference to FIG. 4.

A terminal information editing unit 1300 reads the monitoring results and billing information from terminal information memory unit 1200 and edits them, for example editing character strings in table format, or editing in text format by CSV format, in which each field is separated by a comma (,), etc. CSV, which stands for Comma-Separated Values, is text data in which table-format data or database data is expressed in each field, using a comma as delimiter.

FIG. 4 shows an example of the information format reported from the router of the present invention to the server. In FIG. 4, the user ID 41 identifies the user of the user terminal. For example, it may be a user account, IP address, or e-mail (electronic mail) address.

Name 42 is the name, in which the name of the user of the user terminal is set. The user ID and name are usually set by the system administrator of the router. Starting time 43 is the starting time, which sets the time of day when terminal monitoring unit 1100 monitored each computer 220 and confirmed continuity with the computer. At this time, the date and time of day may be set, and one may also set such information as the day of the week and whether it is a holiday. Stopping time 44 is the stopping time, which sets the time of day when terminal monitoring unit 1100 monitored each computer 220 and could no longer confirm continuity with the computer. In this case, a temporary stop in which continuity cannot be confirmed due to trouble with computer 220 is not counted as this stopping time. Network billing charge 45 is a network billing charge, in which billing information is set concerning the communication time or use quantity in each computer 220 of the SOHO from network 500 (for example, ISDN network or wireless network LAN). The billing information is reset every time it is reported to the server, preventing the billing information from being calculated in duplicate on the part of the server.

Returning to FIG. 2, at preset intervals, a circuit connection unit 1600 makes a dial-up connection to a head-office server 700 or a user terminal (computer) 800. The dial-up connection is not made if at this time there is no data to be transferred from information transfer unit 1400 to server 700 or user terminal 800.

The data (FIG. 4) edited into e-mail format by terminal information editing unit 1300 is sent to server 700 (it may also be a terminal) of management division 200 as e-mail from information transfer unit 1400. At this time, the monitoring information based on the e-mail may be stored on a hard disk, etc. in file format by information transfer unit 1400. If at this time one is able to reference these files from FTP (file transfer protocol) server 1610 or WWW (World Wide Web) server 1620 by having the date and time included in the file name, it will be possible to obtain in a timely way the monitoring information of the desired date and time from computer 800, etc. using an FTP client tool or WWW browser.

Also, if the monitoring information based on the e-mail is stored in file format on a hard disk, etc., one may convert it into tagged-text format and register it with WWW server 1620. For example, HTML format, etc. is included in a tagged-text format.

The network circuit connection unit 1600 holds the e-mail accepted from information transfer unit 1400 and on the occasion of preset conditions sends it to, for example, server 700 of management division 200. At server 700 that receives the e-mail, the content of this e-mail is analyzed, and one can ascertain the state of operation of each computer 120 of SOHO 100 as operation conditions (work conditions). And by comparing each work report with each billing information, one can to a certain extent ascertain the propriety of the operation content.

Also, network circuit connection unit 1600 may have a WWW server 1610, making it possible to use a WWW browser from head-office management division 200 and reference the same data as the aforesaid e-mail. Also, network circuit connection unit 1600 may have an FTP server function 1620, making it possible to use FTP client tools from computer 220 at head-office management division 200 and reference monitoring information, after downloading it, using an editor, spreadsheet software, etc. That is, using for example computer 220 at management division 200, it is possible to reference data of the format shown in FIG. 4 from WWW server 1610 or FTP server 1620. By classifying the data files at that time by date and time of day (for example, including the date and time of day in the file name), one can easily look up and reference the data file containing the desired monitoring information.

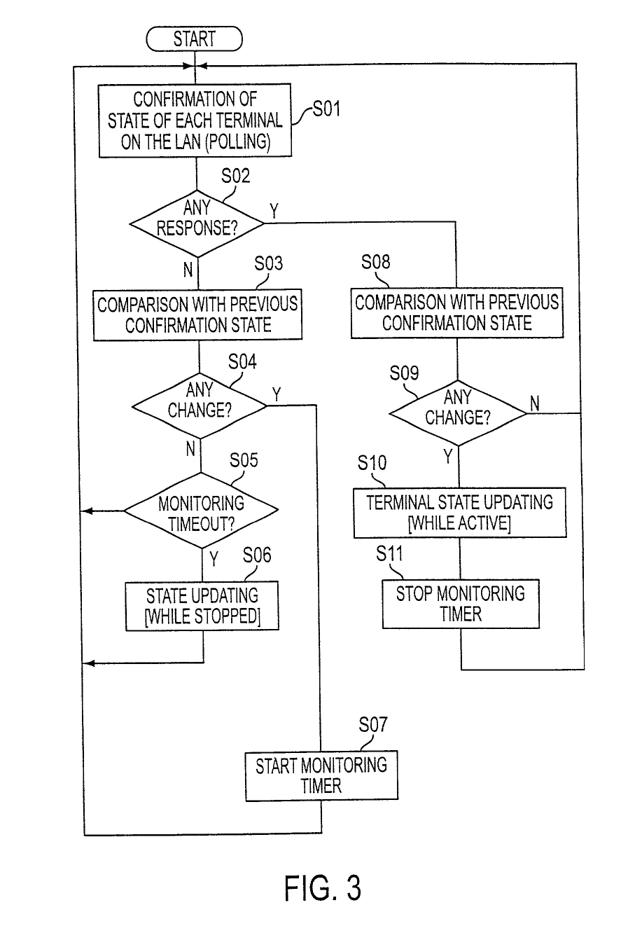

Next, FIG. 3 is a flowchart for explaining an example of a processing flow for deciding a state of a user terminal connected to a router of this invention. The processing flow of terminal monitoring unit 1100 is explained along the lines of this FIG. 3.

In step S01, a ping message is sent one after another to computers 220 in order to confirm the state of each computer 220 connected to router 1000.

In step S02, it is decided that a computer 220 from which a reply comes back is in operation, and one proceeds to step S08. Otherwise (no reply), one proceeds to the following.

In step S03, one compares the previous and current ping results of each computer 220.

In step S04, if different from the previous ping results, one proceeds to step S07.

In step S05, one decides whether the monitoring timer activated for a computer 220 in step S07 has timed out, and if not, one returns to step S01.

In step S06, one updates the state of the computer 220 from still active to stopped. Then one returns to step S01.

In step S07, one activates the timer and monitors the computer 220. Then one returns to step S01.

In step S08, because there has been a reply to the ping, a comparison is made with the previous ping results of that computer 220.

In step S09, if as a result of the comparison there has been no change in the state of the computer 220 (and there is a reply the previous time as well), one returns to step S01.

In step S10, one updates the state of the computer 220 to still active (in operation).

In step S11, one stops the timer that was activated for the computer 220 in step S07. Then one returns to step S01.

By the above-described processing flow, one can monitor the state of each computer 220 and ascertain whether each computer 220 is in operation as a network computer. That is, one can infer whether the user of each computer 220 is present or absent.

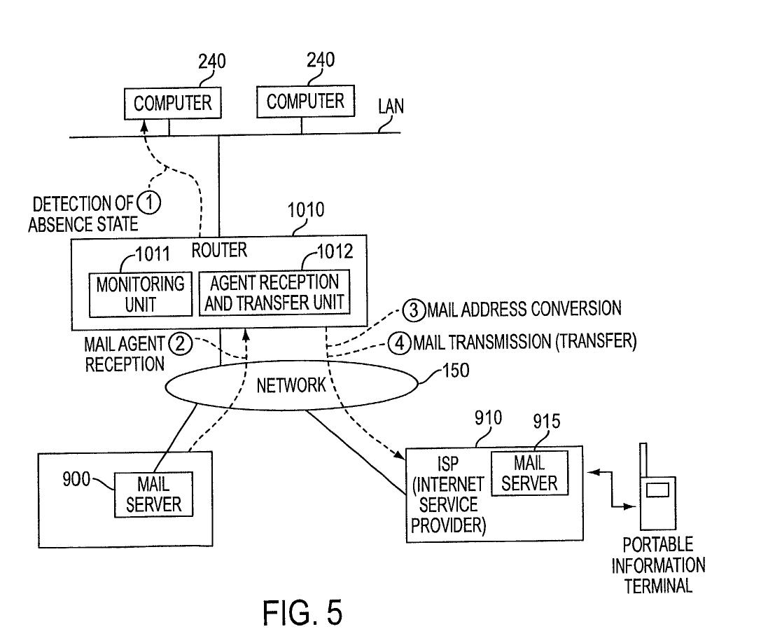

Another embodiment of this invention will be now described along the lines of FIG. 5.

FIG. 5 shows an outline of the transfer operation of e-mail by a router of the present invention. A router 1010 includes a monitoring unit 1011 and an agent reception and transfer unit 1012. If the user of a computer 240 moves outside due to a business trip, etc., the router 1010 receives e-mail addressed to the user of computer 240 and transfers it to a portable information terminal having Internet mail reception function.

In FIG. 5, 1 in a circle is a step in which one detects whether the user of computer 240 is present. Monitoring unit 1011 monitors and samples the operating condition (e.g. starting time, stopping time, and preset user ID and name) of the user terminals (computers 240) connected to router 1010, and maintains their operating condition (monitoring results).

In the monitoring results of computers 240 held by the monitoring unit 1011, any change between the previous and current monitoring results is reported to agent reception and transfer unit 1012.

In 2 in a circle, agent reception processing is done, triggered by detection of the absence of the user.

If, based on the report from monitoring unit 1011, agent reception and transfer unit 1012 judged that a certain computer 240 is in stopped state (a state in which it is not logically connected with router 1010), then agent reception and transfer unit 1012 performs e-mail agent reception processing to mail server 900 or mail server 915 using the preset user account (user identifier) of that computer 240 and, if necessary, the password for that account.

In 3 in a circle, processing is done to convert the received e-mail address to the transfer destination address.

Agent reception and transfer unit 1012 executes processing to transfer the agent-received e-mail to the transfer destination address. In 4 in a circle, the agent-received e-mail is transferred to the specified transfer destination address.

Transfer processing is done on the agent-received e-mail according to the user's previously desired e-mail transfer destination address. At this time, it can be transferred to multiple transfer destination addresses if multiple transfer destination addresses have been defined. In this case, it is desirable to set the e-mail address of a portable information terminal (for example, a portable telephone) that can access Internet e-mail. Of course, it does not matter if it is an ordinary mobile computer, but in this case, the e-mail can be received from there if one can directly access mail server 900 or mail server 915, without using agent reception and transfer unit 1012 provided on router 1010.

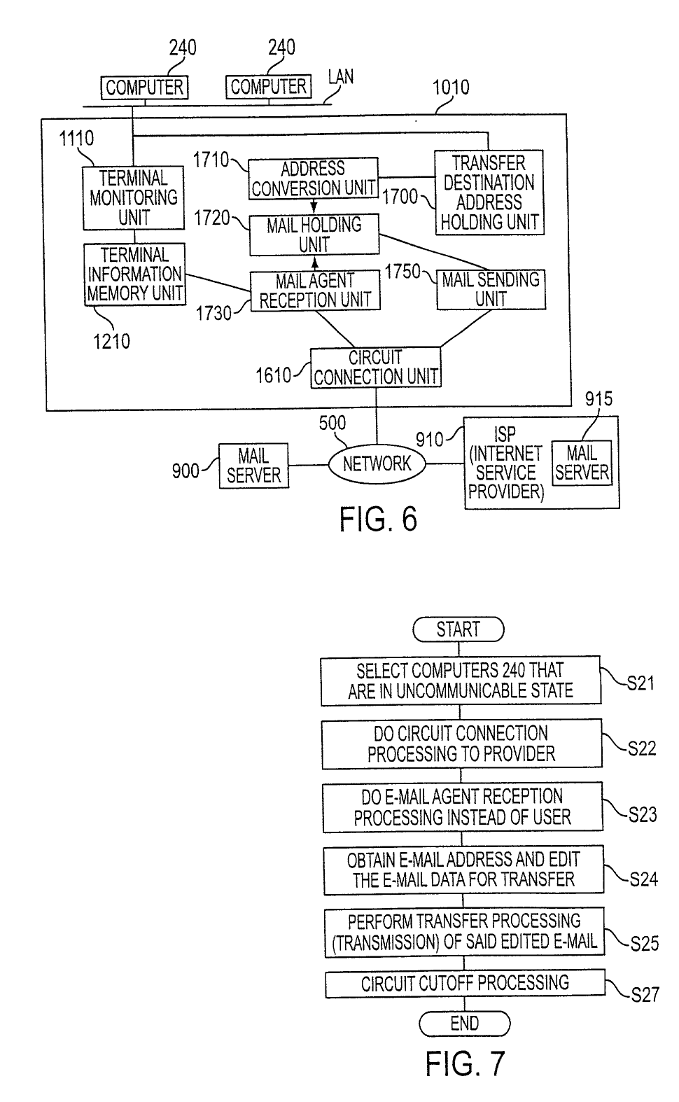

FIG. 6 shows a working example by which e-mail is transferred to a user terminal that is connected to a router of this invention. In FIG. 6, a terminal monitoring unit 1110 monitors each computer (user terminal) 240 connected to a router 1010 at fixed and/or variable intervals to check whether it is in communicable state or incommunicable state. The terminal monitoring unit 1110 polls each computer 240 (for example, using a function equivalent to a ping command, it throws out a ping to the relevant computer 240 and ascertains whether there is any response from that computer 240), and if there is a response from the computer 240, it is known that that user terminal 240 is in operation (in communicable state).

If, on the other hand, there is no response, it is known that it is not in operation (in incommunicable state), but if it is presently not in operation but was in operation shortly before, trouble might have occurred such as the operating system of computer 240 being temporarily down. Therefore if the absence of response continues for a fixed time or longer, it can be inferred that the user of the computer is absent.

In this way, terminal monitoring unit 1110 ascertains the communicability state of each computer 240, and a circuit connection unit 1610 makes dial-up connection to Internet service provider 910 at preset intervals. Or, it may make dial-up connection to in-company mail server 900. Then a mail agent reception unit 1730 and/or a mail sending unit 1750 performs e-mail reception and/or transmission operation with respect to mail server 900 or 915. Also, all or some of the computers 240 monitored by terminal monitoring unit 1110 may be connected to router 1010. When some computers 240 are subject to monitoring, it is necessary to have an identifier (for example, IP address or MAC address, etc.) for each computer 240 covered by router 1010.

The e-mail addressed to computer 240 is received by mail agent reception unit 1730 from mail server 915 of Internet service provider 910 or in-company mail server 900 (hereafter referred to collectively as the mail server) via circuit connection unit 1610 and is stored in a mail holding unit 1720.

At this time, the mail holding unit 1720 makes an inquiry to address conversion unit 1710, which has a correspondence table of reception destination mail addresses of agent-received mail and transfer destination mail addresses, and obtains the transfer destination mail address that corresponds to the addressee destination address of the agent-received mail.

Also, transfer destination address holding unit 1700 receives from the user of each computer 240 the correspondence information between this user's mail address and the mail address of the transfer destination. Then transfer destination address holding unit 1700 reports this to address conversion unit 1710, and address conversion unit 1710 holds the correspondence information and responds to the inquiry from mail holding unit 1720.

The mail holding unit 1720, which has obtained the transfer destination mail address from address conversion unit 1710, sends the mail to mail sending unit 1750 for transferring it to the transfer destination mail address. The mail sending unit 1750 makes a connection with the mail server via circuit connection unit 1610 and sends this e-mail. At this time, specified characters or a specified character string may be included in the title of the e-mail to be transferred.

For example, if it is “moving up of time for sales meeting” as the title of the e-mail, one may include the specified character string “→ moving up of time for sales meeting” or “moving up of sales meeting ←”. In this way, by including specified characters or a specified character string in the title, from the fact that the specified characters or specified character string is included in the title of the received mail, mail agent reception unit 1730 is able to refuse agent reception and can receive this mail when the user's computer 240 is able to communicate. That is, the e-mail is maintained in the unread state. Also, with the title of the e-mail, mail agent reception unit 1730 is able to obtain the currently arriving mail title (subject) and the mail address of the sender without receiving the e-mail. While referencing this title, one can decide whether it is an e-mail that should be agent-received.

By using a unique transmission origin mail address when transferring agent-received e-mail, if the transmission origin mail address of the e-mail to be transferred agrees with the mail address used when making an agent reception transfer, then if reception is refused, one obtains the same results as state above. That is, one can judge whether it is an e-mail that should be agent-received.

FIG. 7 is a flow chart diagram of the processing flow for transferring e-mail by the router of this invention.

In FIG. 7, in step S21, one selects the computers 240 that are currently in incommunicable state.

In step S22, line (circuit) connection processing for making a connection to a mail server (provider) is carried out as preliminary processing for doing agent reception of e-mail.

In step S23, agent reception processing of e-mail is done on behalf of the owner of each computer 240 that is in incommunicable state in step S21.

In step S24, one obtains the e-mail address of the transfer destination of the e-mail agent-received in step S23 and edits the e-mail data for transferring it.

In step S25, one does transfer processing (transmission) of the edited e-mail.

In step S26, processing is done to cut off the line that is connected to the mail server.

Also, steps S21 through S26 are executed at fixed intervals.

### Effects of the Invention

As explained above, this invention has the following effects.

The present invention makes it easy to ascertain the working state of the user at a terminal connected to the router based on information on whether the terminal is logically connected to the router.

The present invention also makes it possible to accurately obtain information on whether a terminal is logically connected to the router by setting the terminal to incommunicable state when it is in incommunicable state consecutively for a prescribed number of times or more.

The router system of the present invention can convey information in a timely way by agent-receiving e-mail on behalf of the user of a terminal that is in incommunicable state and transferring the received e-mail to the desired transfer destination.

Further, due to the present invention an agent-received e-mail is not re-transferred even when it is transferred to one's own mail address, so the e-mail can be received when one is present.

What is claimed is:

1. A packet communication system comprising:
a monitoring unit which monitors each communicability state of terminals, detects a change between a current communicability state of the terminals and a previous communicability state of the terminals, and generates monitoring results in accordance with detecting the change; and
a editing communication unit which edits the monitoring results of the terminals and transmits edited monitoring results on a network.

2. The packet communication system of claim 1, wherein the editing communication unit sets to incommunicable state a terminal that has been in incommunicable state for a period of time or longer.

3. The packet communication system of claim 2, further comprising a server wherein the editing communication unit edits the monitoring results of the terminals in e-mail format and transmits edited monitoring results to the server.

4. The packet communication system of claim 1, further comprising a World Wide Web server, wherein the communication editing unit edits the monitoring results of the terminals in tagged-text format and provides the edited monitoring results to the World Wide Web server as a file name including a date and/or time of day.

5. The packet communication system of claim 2, wherein the server is an FTP (File Transfer protocol) server and the communication editing unit edits the edited monitoring results into table-format data and provides the edited monitoring results to the FTP server as a file name including date and/or time of day.

6. The packet communication system of claim 3, wherein billing information corresponding to the communication executed by the terminals is included in the edited monitoring results.

7. A packet communication system comprising:
a monitoring unit which monitors each communicability state of terminals and stores the communicability state in the monitoring unit; and
an agent reception and transfer unit which, when at least one terminal is in an incommunicable state detected by the monitoring unit, the agent reception and transfer unit receives e-mail instead of a user of a terminal that is in the incommunicable state and transfers the received e-mail to a desired transfer destination.

8. The packet communication system of claim 7, wherein the agent reception and transfer unit which receives e-mail instead of the user, including one or more prescribed characters in a title of the received e-mail, and transfers the received e-mail to the desired transfer destination.

9. The packet communication system of claim 7, wherein if the prescribed characters are included in the title of the e-mail, the agent reception and transfer unit sets the e-mail to be in unread state.

10. The packet communication system of claim 7, wherein if an e-mail address of the transmission origin of the e-mail before the e-mail is received agrees with the e-mail address used by the agent reception and transfer unit, the agent reception and transfer unit sets the e-mail to be in unread state.
